(19) United States
(12) Patent Application Publication
(10) Pub. No.: US 2006/0056689 A1
(43) Pub. Date: Mar. 16, 2006

(54) Image segmentation using template prediction

(75) Inventors: Rimmert B Wittebrood, Eindhoven (NL); Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/535,059

(22) PCT Filed: Oct. 28, 2003
(86) PCT No.: PCT/IB03/04813

§ 371 Date: May 13, 2005

(30) Foreign Application Priority Data
Nov. 19, 2002 (EP) 02079799.9

(51) Int. Cl. G06K 9/34

(52) U.S. Cl. 382/173

(57) ABSTRACT

The invention relates to image segmentation using templates and spatial prediction. The templates of neighboring pixels are used for predicting the features of a current pixel. The pixel is assigned to the segments of neighboring pixels according to the deviation of its features from the templates.

The invention relates to a method for segmenting images into groups of segments, said segments being based on image features, with the steps of determining a group of pixels :for segmenting, and determining for said group feature characteristics.

The invention further relates to a device for calculating image segmentation comprising grouping means for grouping pixels of images into a group of pixels, and extracting means for extracting feature characteristics from said groups.

Eventually the invention relates to the use of such a method and such a device.

Image segmentation is essential to many image and video processing procedures, like object recognition, and classification, as well as video compression, e.g. for MPEG video streams.

For the result of an image segmentation it is essential which characteristics or features are used for segmentation. An image segment may be defined as an image region in which the feature or some features are more or less constant or continuous.

Besides the features which are used for image segmentation, the method of segmentation is essential for the segmentation result. In case a segment is defined as an image region in which a feature is more or less constant or continuous, the segmentation process has to group segments with equal or similar features into segments that satisfy this definition.

A possible process of segmentation is a method which depends only on the difference between features of a current group and features of neighboring groups. In case neighboring groups are already segmented, it is known which segment they belong to. Thus by comparing the features of the current group with the segments of the neighboring groups, the current group may be classified. If the feature of the current group deviates by a value higher then a threshold value, a new segment is started. In case the feature of the current group deviates only slightly or is equal to a feature of a neighboring group, the current group is assigned to the best matching segment.

This so called local prediction method only looks at the differences between the feature of the current group and the features of the neighboring groups. This calculation of and error value may be carried out by different measures, such as a comparison of a vector norm ∥.∥₁ of features. In case the features are luminance (Y), and chrominance (U, V), histograms of each group may be calculated for these values. The histograms of neighboring groups may be defined as \vec{Y}ᵢ, \vec{U}ᵢ, and \vec{V}ᵢ, with i=1, . . . , 4 for four neighboring groups of a current group. The histograms of the current group may be defined as \vec{Y}_{c}, \vec{U}_{c}, and \vec{V}_{c}. The feature \vec{F}ⱼ of a location j may then be written as \vec{F}ⱼ={\vec{Y}ⱼ, \vec{U}ⱼ, \vec{V}ⱼ}. For local prediction, where the feature of the local group is \vec{F}_{c}, an error value ε of a current group may be calculated as
ε(\vec{F}_{c},\vec{F}ⱼ)=∥\vec{Y}_{c}−\vec{Y}ⱼ∥₁+∥\vec{U}_{c}−\vec{U}ⱼ∥₁+∥\vec{V}_{c}−\vec{V}ⱼ∥₁

Every segment i corresponds to a label lᵢ and during segmentation, every group in the image is assigned such a label. The algorithm for calculating the segmentation of the groups maybe described as follows:
if ε(\vec{F}_{c},\vec{F}ⱼ)>T for j=1, . . . , 4 then

start new segment

else

assign label Iₖ to group for which
ε(\vec{F}_{c},\vec{F}ₖ)=min{ε(\vec{F}_{c},\vec{F}ⱼ)}, j=1, . . . , 4

end

where \vec{F}ⱼ represents the feature located at the j-th position in the neighborhood of the current group. By segmenting the groups according to this method, only local information is taken into account. In case features between neighboring groups deviate only little, the groups are segmented together, as the error value does not exceed the threshold value T. To avoid merging of groups with small differences, the threshold value may be low. But then the slightest deviation in the feature causes the creation of a new segment. This has the drawback of heavy over-segmentation within the image.

As shown above, current methods have the drawback of over-segmentation or computational complexity. These methods are not well suited for use with image and video material.

It is thus an object of the invention to provide a method, and a device which allows for image segmentation with low computational complexity. It is a further object of the invention to provide a method, and a device which is robust and allows for segmentation even with noisy images. It is a further object of the invention to provide a method, and a device which copes with the constraints surrounding image and video materials. It is yet a further object of the invention to provide a method,and a device which takes spatial and/or temporal consistency into account and allows for real-time implementation.

These and other objects of the invention are solved by a method for segmenting images into groups of segments, said segments being based on image features, with the steps of determining from neighboring groups segment templates, said segment templates describing constant features within said neighboring groups, calculating for said group as continuous error values by comparing features of said group with features of said segment templates, and deciding to assign said group to one of said segment templates, or to create a new segment template based on said error values.

An image according to the invention may by a still picture or an image within video. A segment may be defined as an image region in which certain features are more or less constant or continuous. Features may be luminance or chrominance values, statistical derivates of these and other picture values like standard deviations, skewness or kurtosis. Features may also be luminance and chrominance histograms, or based on co-occurrence matrices. Even fractal dimensions may be used for defining features. The feature for segmenting the image depends on the purpose of the segmentation. Different applications profit from different segmentations based on different features.

A group of pixels may be a block of N×M pixels, in particular 4×4, 8×8, 16×16, or 32×32 pixels, but not necessarily N=M.

A template describes the feature, which may be constant or continuous throughout a segment. A list of segments may be maintained, describing different features of segments. For example, a template may be a weighted average of the feature encountered within a segment. If the feature of a group differs too much from a template within the template list, a new segment may be started. Otherwise, the group is assigned to the best matching template.

When segmenting an image, the scanning of the image is carried out from one group to the next group. Thus, neighboring groups of a group might have been segmented already. This segmentation may be used for segmenting of the current group, thus using local information.

According to the invention, this local information is used for segmenting. The feature of a current group is compared to the segment templates of the neighboring groups. If the feature matches one of the segment templates of the neighboring groups, the current group is assigned to the best matching neighboring segment. In case the feature of the current group does not fit into any of the neighboring segment templates, a new segment is started with a different segment template.

The error value may be calculated by using various kinds of calculation methods known in the art.

To calculate a segmentation mask for a whole image, a method according to claim 2 is preferred.

To account for spatial and temporal differences within an image or a sequence of images within a video, a method according to claim 3 is proposed, as thus also motion estimation is possible.

A method according to claim 4 is a preferred embodiment of the invention. To ensure low computational complexity, the segmentation process has to match the memory layout, e.g. the scanning order should match the memory layout. An image is usually stored in an 1-dimensional array. The array starts with the top-left pixel of the image and ends with the bottom-right pixel, or vice versa To allow for efficient caching of neighboring segment templates the scanning direction should also be performed from left-to-right and from top-to-bottom, or vice versa

With spatial or temporal caching of neighboring segment templates, the information which is processed previously may be used for the current group.

The threshold value according to claim 5 allows for adjusting the segmentation according to image particularities, e.g. noise values.

With methods according to claims 6 to 8, the segmentation may be adjusted for the purpose of segmentation, as different features used for segmenting yield different results.

To account for motion segmentation, a method according to claim 9 is proposed. Thereby groups of pixels may be characterized by their motion, which motion may be represented by a motion template.

In case image information is used for segmentation, according to claim 10, segmentation may also be carried out based on position information of an image, e.g. if different zones within an image have to be segmented with different features.

Another aspect of the invention is a device according to claim 11, comprising grouping means for grouping pixels of images into groups, extracting means for extracting feature characteristics from said groups, storing means for storing segment templates of neighboring groups, comparing means for comparing said extracted features with features of said segment templates, decision means for assigning said group of pixels to one of said segment templates or to create a new segment template based on error values determined between said extracted features and features of said segment templates.

Yet another aspect of the invention is the use of a pre-described method or a pre-described device in image and/or video processing, medical image processing, crop analysis, video compression, motion estimation, weather analysis, fabrication monitoring, and/or intrusion detection. Video and image quality will be increasingly important in consumer electronics and industrial image processing. To allow for efficient image compression and correction, a better understanding of the image content is necessary. To increase this knowledge, image segmentation is an important tool. Image segmentation according to the invention may be carried out cost effective and with low hardware complexity. Thus enabling motion estimation and compression as well as image enhancement within the mass market.

These and other aspects of the invention will be elucidated with and will become apparent from the following figures. In the figures show:

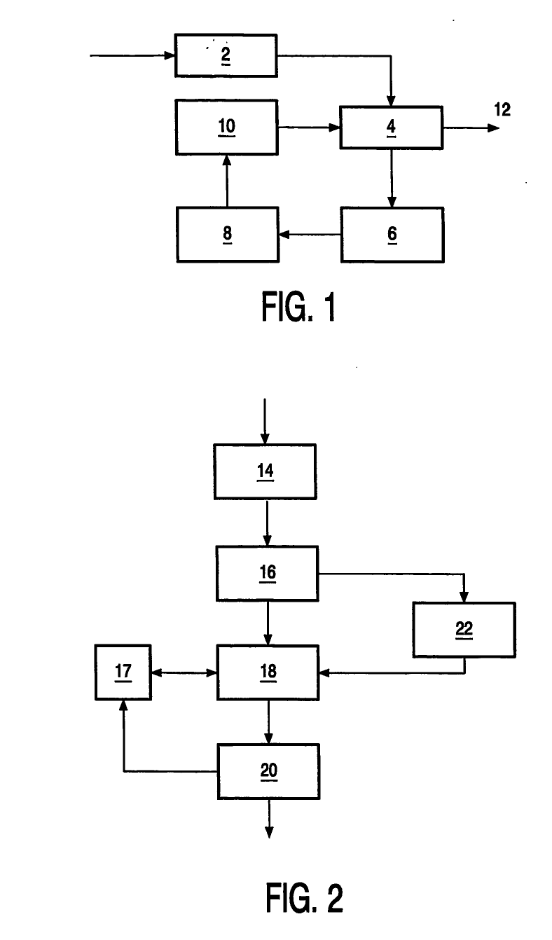

FIG. 1 a method according to the invention;

FIG. 2 a device according to the invention;

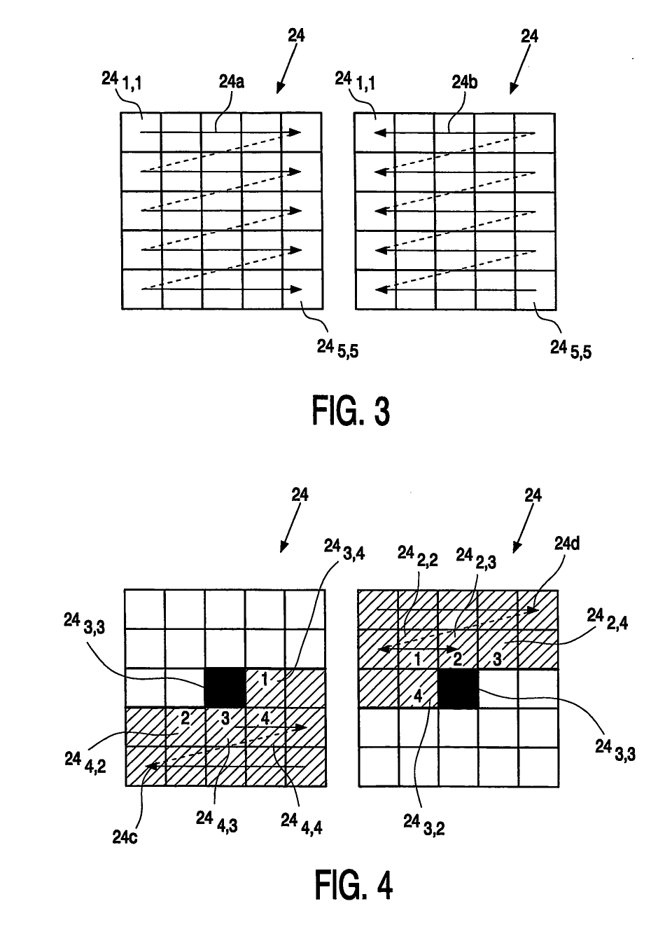

FIG. 3 a memory array;

FIG. 4 scanning of a memory array.

FIG. 1 depicts a method according to the invention. In a first step 2, the feature characteristics of an image are extracted. These feature characteristics are compared to features of segment templates of neighboring groups of pixels in step 4.

In case the features of the current group deviate from the features of the segment templates of neighboring groups, a new segment template is created based on the features of the current group in step 6. This new segment template is stored in step 8, together with the already stored segment templates. These segment templates represent already segmented groups of pixels.

Based on the stored segment templates, the segment templates of neighboring groups of pixels are used for predicting the template of a current group in step 10. That means, that from the stored segment templates, the templates referring to the groups of pixels which are adjacent to the current group of pixels are extracted. Preferably, in case of memory matched scanning, these are the three groups in the row above the current group and the one group on the left side of the current group. These four templates are used for predicting the template of the current group.

As already pointed out, in step 4 the features of the current group are compared with the features of the neighboring segment templates. An error value is calculated, based on which the current group is assigned to a neighboring segment or a new segment is created.

After all groups of the image have been scanned and segmented, a segmentation mask is put out 12, which is a segmented representation of the current image, based on the features used for segmentation.

In case the segmentation is block based, all pixels of a block are assigned to one segment. This reduces calculation complexity drastically. The segmentation may be carried out on video streams such as PAL or NTSC. Within these video streams, strong cues for image segmentation are luminance (Y) and chrominance (U, V), and texture. These features can be efficiently captured in three histograms, an 8 bin histogram for luminance value Y and a 4 bin histogram for chrominance values U, V, respectively. Motion information may also be used in addition to these features.

It is important that the bins are used effectively and since the histograms can be localized, it is important that the minimum and maximum values are determined. Based on these minima, and maxima, the bins can be evenly distributed between these values. The minimum and maximum values may be determined from previous images within the video stream.

To account for noise within the image, the minimum and maximum values are set to those values for which 5% of the samples are lower than the minimum and 5% of the values are higher than the maximum. Samples falling outside the bins are assigned to the outside bins.

The histograms of neighboring groups may be defined as \vec{Y}ᵢ, \vec{U}ᵢ, and \vec{V}ᵢ, with i=1, . . . , 4 for the four neighboring groups of a current group. The histograms of the current group may be defined as \vec{Y}_{c}, \vec{U}_{c}, and \vec{V}_{c}. The feature \vec{F}ⱼ of a location j may then be written as \vec{F}ⱼ={\vec{Y}ⱼ,\vec{U}ⱼ,\vec{V}ⱼ}. For local prediction, an error value ε of a current group maybe calculated as
ε(\vec{F}_{c},\vec{F}_{J})=∥\vec{Y}_{c}−\vec{Y}ⱼ∥₁+∥\vec{U}_{c}−\vec{U}ⱼ∥₁+∥\vec{V}_{c}−\vec{V}ⱼ∥₁

Every segment i corresponds to a label lᵢ and during segmentation, every group in the image is assigned such a label. The feature of the local group is defined as \vec{F}_{c}.

The prediction of local segmentation is described earlier, whereby based on the error value a new segment is created or the group is assigned to the best matching segment of the neighbors.

The advantage of local difference is that local information is used for the segmentation process. This results in a spatial consistency of the segmentation. This spatial consistency is lost when segmentation is carried out only using global templates.

A segment with label lᵢ has a template denoted by \vec{T}ᵢ, by which features within a group are represented. For global template matching, the templates of all segments within an image are stored and the current feature is compared to the features of all templates of the image. To assign a group to a segment, the following steps are carried out:
if ε(\vec{F}_{c},\vec{T}ᵢ)>T for i=1,2, . . . then

start new segment

else

assign label lₖ to group for which
ε(\vec{F}_{c}\vec{T}ₖ)=min{ε(\vec{F}_{c},\vec{T}ᵢ)},i=1,2,

end

During segmentation, for each group all templates have to be compared to the current group, increasing computation complexity. Templates from segments with no spatial correlation to the current group are used for segmentation, which results in noisy segmentation.

To allow for segmentation using templates, thus preventing merging of segments with gradual change in features and also to allow for low computational complexity as with local segmentation, a new segment is started if the feature of the current block deviates too much from the features of the templates surrounding the current block. With \vec{T}ⱼ^{p} representing the template of the segment located at the j-th position adjacent to the current block, the segmentation may be carried out according to the invention as follows:
if ε(\vec{F}_{c},\vec{T}ⱼ^{p})>T for j=1, . . . , 4 then

start new segment

else

assign label lₖ of template for which
ε(\vec{F}_{c},\vec{T}ₖ)=min{ε(\vec{F}_{c},\vec{T}ⱼ^{p})}, j=1, . . . , 4

end

By comparing the features of the current group with segment templates of the neighboring segments, local information may be used as well as computational complexity may be kept low.

A device for segmenting an image is depicted in FIG. 2. Depicted is a grouping means 14, an extracting means 16, a strong means 17, a comparing means 18, a decision means 20 and a second storing means 22. The device works as follows:

An incoming image is grouped into groups of pixels by grouping means 14. The groups may be blocks of pixels, e.g. 8×8, 16×16, or 32×32 pixels. From these groups, feature characteristics are extracted by extracting means 16. For each group, the feature characteristics is stored in second storing means 22. Comparing means 18 compares the feature characteristics of each group with the segment templates of neighboring groups, stored in storing means 17. Decision means 20 decide whether the deviation of the features of the current group exceeds a threshold value from the features of the neighboring segment templates. In case the deviation exceeds the threshold value, a new template is created and stored within storing means 17. In all other cases, the current group is assigned to the best matching template of the neighboring groups. After all groups are segmented, a segmentation mask is put out.

FIG. 3 depicts a memory array 24 for storing an image. The pixels are stored from the top-left position 24_{1,1} of the array 24 to the bottom-left position 24_{5,5} of the array 24, as depicted by arrow 24a. It is also possible that the pixels are stored from the bottom-left position 24_{5,5} of the array 24 to the top-left position 24_{1,1} of the array 24, as depicted by arrow 24b.

With memory matched scanning, the scanning direction should match the storing direction, as depicted in FIG. 4. In case the scanning is memory matched, the scanning direction is according to arrows 24c or 24d, depending on the storing direction 24a, b.

In the first embodiment, the scanning is from bottom-right to top-left according to arrow 24c. For segmenting the pixel at position 24_{3,3} the segment templates of the neighboring pixels 24_{4,4}, 24_{4,3}, 24_{4,2}, 24_{3,4} are known. Pixel 24_{3,3} is assigned to one of the segment templates of the neighboring pixels 24_{4,4}, 24_{4,3}, 24_{4,2}, 24_{3,4} or a new segment template is created, based on the deviation value.

In the second embodiment, the scanning is from top-left to bottom-right according to arrow 24d. For segmenting the pixel at position 243,3 the segment templates of the neighboring pixels 24_{2,2}, 24_{2,3}, 24_{2,4}, and 24_{3,2} are known. Pixel 24_{3,3} is assigned to one of the segment templates of the neighboring pixels 24_{2,2}, 24_{2,3}, 24_{2,4}, and 24_{3,2} or a new segment template is created, based on the deviation value.

By using spatial information as well as template matching, segmentation will be fast and robust. Image segmentation, compression and enhancement may be carried out on-line to video streams in many applications such as consumer electronics, MPEG streams, and medical applications at low cost.

1. Method for segmenting images into groups of segments, said segments being based on image features, with the steps of:
a) determining a group of pixels for segmenting,
b) determining for said group feature characteristics,
c) determining from neighboring groups segment templates, said segment templates describing constant or continuous features within said neighboring groups,
d) calculating for said group error values by comparing features of said group with features of said segment templates, and
e) deciding to assign said group to one of said segment templates, or to create a new segment template based on said error values.

2. Method according to claim 1, with the steps of determining for said image a plurality of groups and carrying out the steps a)-e) for all groups of said image.

3. Method according to claim 1, characterized in that said segment templates are determined spatially and/or temporally.

4. Method according to claim 1, characterized in that scanning said groups of pixels for said segmentation is done memory matched.

5. Method according to claim 1, characterized in that said decision to assign said group to one of said segment templates, or to a newly created segment template is based on threshold values.

6. Method according to claim 1, characterized in that said features are based on chrominance, and/or luminance values, statistical derivatives of pixels, histograms, co-occurrence matrices and/or fractal dimensions.

7. Method according to claim 1, characterized in that said segment templates comprise an average luminance and chrominance span of said pixels.

8. Method according to claim 2, characterized in that said segment templates comprise at least one histogram.

9. Method according to claim 3, characterized in that said segment templates comprise motion models.

10. Method according to claim 1, characterized in that said segment templates comprise image position information.

11. Device for calculating image segmentation according to claim 1 comprising:
grouping means for grouping pixels of images into groups,
extracting means for extracting feature characteristics from said groups,
storing means for storing segment templates of neighboring groups,
comparing means for comparing said extracted features with features of said segment templates,
decision means for assigning said group of pixels to one of said segment templates or to create a new segment template based on error values determined between said extracted features and features of said segment templates.

12. Use of a method according to claim 1 in image and/or video processing, medical image processing, crop analysis, video compression, motion estimation, weather analysis, fabrication monitoring, and/or intrusion detection.
